(19) United States
(12) Patent Application Publication
(10) Pub. No.: US 2025/0362095 A1
(43) Pub. Date: Nov. 27, 2025

(54) DUAL SPECTRUM MULTI-LAYER HEAT SPREADING HEAT SHIELD

(71) Applicant: FCA US LLC, Auburn Hills, MI (US)

(72) Inventors: Dipa Pradeepkumar Arora, Sterling Heights, MI (US); Alaa Edeen El-Sharkawy, West Bloomfield, MI (US); Amr Gamal Samy Sayed, 6th of October City (EG)

(21) Appl. No.: 18/670,328

(22) Filed: May 21, 2024

(51) Int. Cl. F28F 13/00; B32B 3/28; B32B 5/02; B32B 5/26; B32B 15/14; B32B 15/20

(52) U.S. Cl. CPC F28F 13/00; B32B 3/28; B32B 5/028; B32B 5/26; B32B 15/14; B32B 15/20; B32B 2255/06; B32B 2255/20; B32B 2262/101; B32B 2262/106; B32B 2264/1025; B32B 2307/304; B32B 2605/00; F28F 2270/00

(57) ABSTRACT

A vehicle heat shield has a first high thermal resistance composite layer, a second high thermal resistance composite layer, and a gap between the first and second layers. The gap disrupts direct heat transfer between the layers. Also, the gap acts as a thermal insulator to prevent heat buildup.

### FIELD

The present disclosure relates to automotive vehicles and, more particularly, to a dual spectrum multi-layer heat spreading heat shield.

### BACKGROUND

This section provides background information related to the present disclosure which is not necessarily prior art.

Modern vehicles have significant thermal challenges and struggle to dissipate the heat from various components. With the advent of high performance engines, that increase engine power, more heat is generated potentially impacting component life spans as well as passenger comfort. In electric vehicles, lithium batteries can overheat and enter a self-sustaining loop generating extreme heat. Also, tightly packed components in the engine compartment limit air flow that creates localized heat pockets further intensifying thermal concerns. Further, the exhaust system generates localized heat impacting nearby components. This leads to component degradation due to the high temperatures that accelerate wear and tear on vital parts like wiring, sensors and plastic components. Also, passenger discomfort increases due to heat radiating from the exhaust that can raise the underbody temperature decreasing cabin comfort especially in hot climates. Thus, it is desirable to reduce the heat in these situations on the components to provide a cooling effect to the components.

The present disclosure provides a protection system to significantly reduce heat exposure and improve component longevity in vehicles. The system utilizes a multi-layer approach with high thermal resistant component layers, air gaps, insulation and a dual spectrum film. Also, heat spreaders may utilized for extreme heat concentration to prevent thermal hot spots.

Accordingly, the present disclosure disrupts direct heat transfer. Also, it minimizes radiation absorption and emission toward the components. The present disclosure efficiently distributes the heat to further improve protection against the heated zone. Also, the present disclosure provides a lightweight and modular design.

### SUMMARY

This section provides a general summary of the disclosure, and is not a comprehensive disclosure of its full scope or all of its features.

According to a first aspect of the disclosure, a vehicle heat shield comprises a first high thermal resistant composite layer. A second high thermal resistant composite layer is present with a gap between the first and second layers. The gap disrupts direct heat transfer between the layers and acts as a thermal insulator to prevent heat buildup. The first and second layers are lined with specialized film. The outer layer has an outside film with low absorptivity and high emissivity film reflecting radiant heat away from the outer layer for a radiant cooling effect. An inner side has a low emissivity film further reducing re-radiation of the captured heat. The inner layer has an outer side with low absorptivity film that mirrors an inner side with a low emissivity film that minimizes heat radiation towards a component. A strategically positioned multi-directional heat spreader may be positioned in the outer composite layer to distribute heat and prevent hot spots.

According to a second aspect of the disclosure, a vehicle having an engine compartment with an engine in the compartment and a heat shield. A vehicle heat shield comprises a first high thermal resistant composite layer. A second high thermal resistant composite layer is present with a gap between the first and second layers. The gap disrupts direct heat transfer between the layers and acts as a thermal insulator to prevent heat buildup. The first and second layers are lined with specialized film. The outer layer has an outside film with low absorptivity and high emissivity film reflecting radiant heat away from the outer layer for a radiant cooling effect. An inner side has a low emissivity film further reducing re-radiation of the captured heat. The inner layer has an outer side with low absorptivity film that mirrors an inner side with a low emissivity film that minimizes heat radiation towards a component. A strategically positioned multi-directional heat spreader may be positioned in the outer composite layer to distribute heat and prevent hot spots.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a heat shield in accordance with the disclosure.

FIG. 2 is a schematic cross-section view of FIG. 1.

FIG. 3 is a perspective view of heat spreader tubes.

FIG. 4 is an end view of the heat shield.

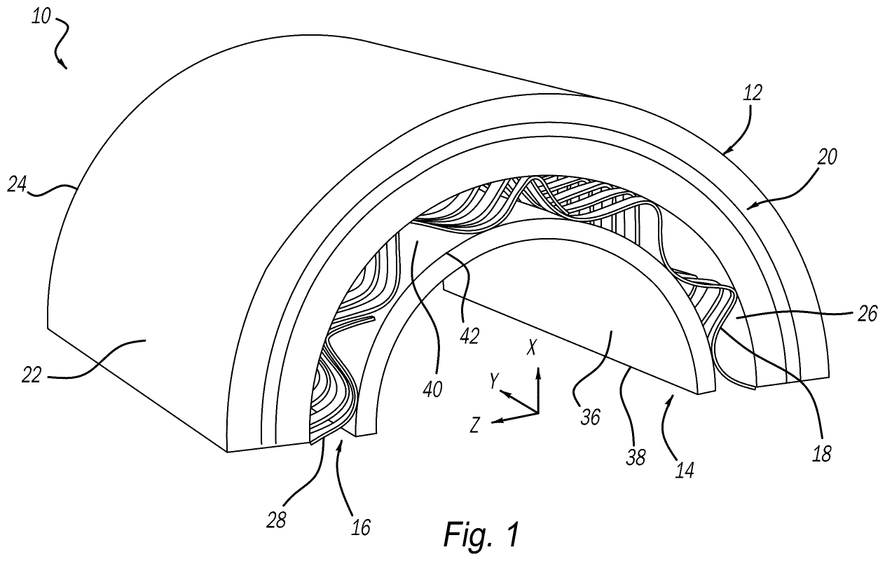

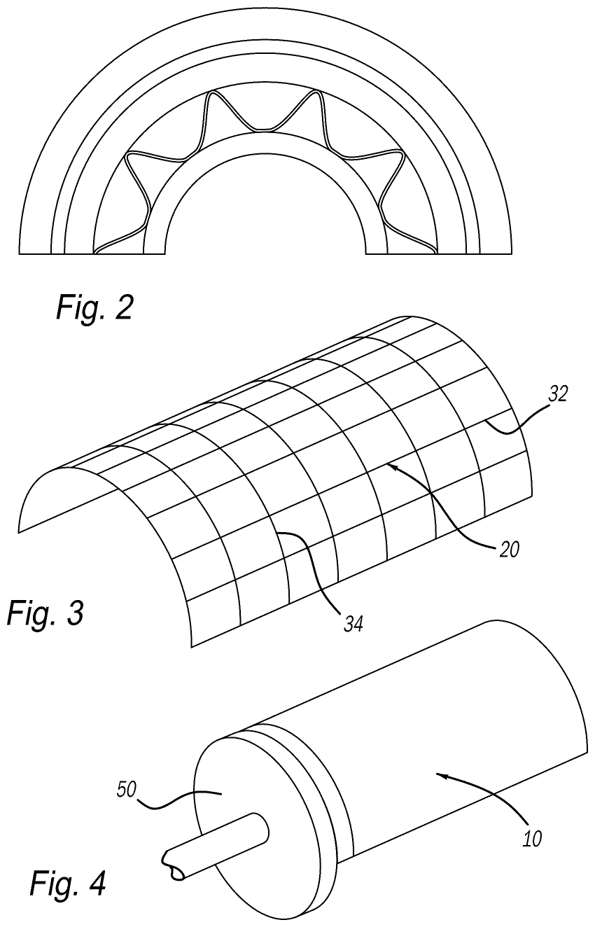

Corresponding reference numerals indicate corresponding parts throughout the several views of the drawings.

### DETAILED DESCRIPTION

Example embodiments will now be described more fully with reference to the accompanying drawings.

Turning to the figures, a heat shield is illustrated and designated with the reference numeral 10. The heat shield 10 includes a first or outer high thermal resistant composite layer 12. Also, it includes a second high thermal resistant composite layer 14. The first and second thermal resistant composite layers 12, 14 are separated by a gap 16 that disrupts direct heat transfer between the first and second layers 12, 14. The gap 16 acts as a thermal insulator to heat buildup.

A spacer 18 may be positioned in the gap 16 between the layers 12, 14. The spacer 18 may be an elongated cylindrical coil having a sinusoidal configuration and be made of a non-conductive material such as plastic. It is to position between the layers 12, 14, with respect to one another. The spacer 18 is spaced along the axis of the heat shield at a desired distance to ensure the gap along the heat shield 10. Also, the first layer 12 may include heat spreader tubes 20.

The first layer 12 includes a film 22 on its outer side 24. Also, it includes a film 26 on its inside 28. The composite layer generally includes an insulated material such as fiberglass or the like between the films 22, 26. The outside film 22 is of low absorptivity and high emissivity film. A film such as aluminum foil or the like may be used. Also, film such as Polydimethylsiloxane (PDMS) and TiO22 microparticles Film Micromachines|Free Full-Text|Development of High-Performance Flexible Radiative Cooling Film Using PDMS/TiO2 Microparticles (mdpi.com) may be used. The inner film 26 is of a high absorptivity and emissivity film. The film may be an aluminum foil treated with nanoparticles with high emissivity film as aluminum Foil with ultrathin folded highly-lossy (UFHFs) Al-doped ZnO (AZO) film Super broadband mid-infrared absorbers with ultrathin folded highly-lossy films-ScienceDirect may be used.

The outer layer 12 may include the spreader tubes 20. The spreader tubes 20 generally have a mesh configuration like illustrated in FIG. 3. The spreader tubes 20 have axial tubes 32 and radial tubes 34. The tubes form a mesh and dissipate the heat from the layer 12. The heat can be dissipated axially along the tubes 32 to move it away from the hot spot towards the ends of the heat shield. Likewise, the radial tubes 34 move the heat radially to the ends or sides of the layer 12. Thus, the heat spreader tubes 32, 34 provide heat dissipation from the outer layer 12 to the ends inside of the heat shield away from the hot spot and component. The heat spreader 20 may be formed from natural and synthetic graphite sheet such as eGraf® SpreaderShield™ Heat Spreaders-NeoGraf Solutions. Also, pure carbon multiwalled perpendicular nanotubes (CNTs), Fujitsu Successfully Develops Easy to Handle, Flexible Nanotube Adhesive Sheet Technology with High Thermal Conductivity-Fujitsu Global

The inner or second layer 14 has a high absorptivity and low emissivity film 36 on its inner surface 38. Also, it has a lower absorption, high emissivity film 40 on its outer side 42. The films 36, 40 separated by an insulated material such as a fiberglass material 44. Thus, the films 36 and 40 are like films 22, 26 previously discussed.

The heat shield 10 may include a cap 50 at both of its ends. The cap 50 can be designed to maintain the integrity of the first and second layers 12, 14 so that they are spaced from one another to have the gap 16 between the two. Also, the cap 50 may include an aperture to enable passage of the component 60 so that the component is positioned beneath the heat shield 10 away from the heat source. Thus, the heat shield 10 can be maintained above the component 60, via the caps 50, at each end of the heat shield 10. The heat source may be an internal combustion engine, batteries, exhaust or the like. The protective components may be fuel tanks, battery packs, electronics, brake lines, urea lines and fuel lines. Thus, the heat shield is positioned above the component to dissipate heat from the heat source away from the component 60.

The present disclosure's air gap 16 effectively isolates the heat source minimizing conduction between the two layers 12, 14. Also, the spectrum films 22, 26, 36, 40 significantly reduce heat absorption from the heat source and re-radiation towards the components. The heat spreader 20 mitigates concentrated heat zone to further improve protection.

The heat shields 10 are lightweight and adaptable to various vehicle configurations. Also, the heat shields 10 can be modified in length to provide the desired properties. The heat shields 10 provide superior radiation control compared to traditional heat shields.

The strategically placed air gap 16 offers enhanced thermal resistance compared to direct contact solutions of the prior art. The heat spreader 20 addresses extreme heat concentrations suppressing the capability of most existing systems to dissipate heat from the heat shield 10. The system avoids any weight and complexity drawbacks of traditional liquid or active cooling solutions. The present design offers significant advantages in the term of component longevity, passenger comfort and overall vehicle efficiency. The heat shield 10 enhances the thermal management of the automotive vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle heat shield comprising:
a first high thermal resistance composite layer;
a second high thermal resistance composite layer; and
a gap between the first and second layers for disrupting direct heat transfer between the layers, the gap acting as a thermal insulator to prevent heat buildup.

2. The vehicle heat shield of claim 1, wherein the first and second layers are lined with specialized film.

3. The vehicle heat shield of claim 1, wherein the outer layer has an outer side with a low absorptivity and high emissivity film reflecting radiant heat away from the outer layer for a radiative cooling effect; and
an inner side with a low emissivity film further reducing re-radiation of captured heat.

4. The vehicle heat shield of claim 2, wherein the inner layer has an outer side with low absorptivity film and an inner side with low emissivity film that minimizes heat radiation toward a component.

5. The vehicle engine heat shield of claim 1, further comprising strategically positioning multi-direction heat spreader in the outer composite layer for distributing heat and preventing hot spots.

6. A vehicle having an engine compartment comprising:
an engine in the compartment;
a heat shield in the compartment, the heat shield comprising: ;
a first high thermal resistance composite layer;
a second high thermal resistance composite layer; and
a gap between the first and second layers for disrupting direct heat transfer between the layers, the gap acting as a thermal insulator to prevent heat buildup.

7. The vehicle of claim 6, wherein the first and second layers are lined with specialized film.

8. The vehicle of claim 6, wherein the outer layer has an outer side with a low absorptivity and high emissivity film reflecting radiant heat away from the outer layer for a radiative cooling effect; and
an inner side with a low emissivity film further reducing re-radiation of captured heat.

9. The vehicle of claim 8, wherein the inner layer has an outer side with low absorptivity film and an inner side with low emissivity film that minimizes heat radiation toward a component.

10. The vehicle of claim 6, further comprising strategically positioning multi-direction heat spreader in the outer composite layer for distributing heat and preventing hot spots.
